(19) United States
(12) Patent Application Publication
(10) Pub. No.: US 2012/0192959 A1
(43) Pub. Date: Aug. 2, 2012

(54) WINDSCREEN WIPER WATER SYSTEM

(75) Inventors: Reinhold Wein, Erlangen (DE); Friedhelm Bednarz, Tandern (DE)

(73) Assignees: FROTEK-Vermogensverwaltung GmbH, Osterode am Harz (DE); Rienhold WEIN, Erlange (DE)

(21) Appl. No.: 12/094,981

(22) PCT Filed: Nov. 22, 2006
(86) PCT No.: PCT/EP2006/011176

§ 371 Date: Feb. 25, 2010

(30) Foreign Application Priority Data
Nov. 23, 2005 (DE) 10 2005 055 714.7

(51) Int. Cl. G05D 11/00

(52) U.S. Cl. 137/98

(57) ABSTRACT

The windscreen wiper water system specified for all types of motor vehicle comprises a water collection device (1) for collecting rain water or car wash water falling onto the motor vehicle as collected water, means (4) for filtering and purifying collected water, a wiper-wash container (5), a supply line (2) for feeding the collected water to the wiper-wash container (5) and means (8, 9, 10, 11, 12, 13, 14) for producing a mixture of wiper-wash water and anti-freeze, depending on the outside temperature, for cleaning vehicle windscreens.

The invention relates to a windscreen wiper water system for all types of motor vehicle.

Nowadays, conventional windscreen wiper water systems used in motor vehicles consist mostly of only a container with a spray pump. The container must be manually filled with water and anti-freeze/cleaning fluid. The spray pump sprays the mixture onto the windscreen to be cleaned.

The drawbacks of the system currently used in the automotive industry are that:
the wiper-wash mixture freezes when the dosage of anti-freeze is too low and the freezing point of the solution is not reached.
the maximum concentration of the anti-freeze mixture is filled into the wiper-wash container when the motor vehicle is initially equipped, irrespective of the country and time of year. When refilling, garages use a highly concentrated mixture of water, anti-freeze and a cleaning additive. Between spring and autumn this practice is known to be highly uneconomical and also unecological.
inhalation of alcohol vapours results in a strong unpleasant smell and damage to health. The wiper water contains a high concentration of anti-freeze, the ethyl alcohol evaporates when the mixture is sprayed onto the windscreen and enters the inside of the motor vehicle through the ventilation.
the intervals between refills are often too short depending on the weather.

As is known from DE 199 12 294 A1, the drawback of the short intervals between refills of the wiper water in the container may be reduced by partially collecting water which falls onto the motor vehicle and feeding it to the wiper-wash container.

In winter, minerals (de-icing salt) are washed into the collection container with the water fed back from the windscreen, which results in smears and smudges on the windscreen during use of the cleaner and greatly impedes the cleaning process or makes it impossible. A solution to this problem is disclosed in DE 14422 535 A1. The water flowing into the collection container is purified in a one-stage process using an ion exchanger.

The current practice at car washes provides for liquid wax to be applied to the motor vehicle during the last stage of the washing programme. Said liquid wax is also collected in the wiper water collection container when the water passes back into said container. When using the water as a cleaning fluid on the motor vehicle windscreen, the wax in the water leads to smearing which impedes the cleaning process and makes it impossible.

In order to avoid the wiper-wash anti-freeze mixture from freezing, DE 37 34 130 A1 discloses a possible technical embodiment. With the aid of a density measuring device, a correct mixture ratio of anti-freeze and water depending on the outside temperature can be achieved. The electromechanical realisation of the anti-freeze measurement in the collection container corresponds to the technical possibilities in the late 80s. The technically flawless function is undisputed. A cost-effective conversion with the density measurement is, however, hardly possible. In practice, no such technical solution was previously able to become established.

It is thus already known to recycle rain water to clean motor vehicle windscreens. A series implementation of this idea has not previously taken place in the automobile industry for two reasons. There is currently no complete system which, on the one hand, functions satisfactorily all year round in the most important markets of Europe/USA/Japan and, on the other hand, can be produced at a sensible cost-benefit ratio.

The object of the invention is to improve conventional wiper water collection devices or windscreen wiper water systems in motor vehicles or other windscreen cleaning systems.

In order to achieve this object, a windscreen wiper water system corresponding to the features of claim 1 is disclosed. Advantageous embodiments of the windscreen wiper water system according to the invention will emerge from the features of the claims dependent on claim 1.

The wiper-wash system according to the invention consists of a wiper water collection device for all types of motor vehicle, in which the collected water is filtered and purified, and a mixture of wiper-wash water and antifreeze, depending on the outside temperature, for cleaning motor vehicle windscreens is produced.

The invention is particularly based on multiple-stage filtering with a wax absorber and demineraliser and an electric sensor for measuring the concentration of anti-freeze. It is thus ensured that a technical solution which is functional and economically justifiable can be achieved under all climatic conditions.

Because the wiper-wash container provided according to the invention is refilled, at least in part automatically, the interval between possible manual refills required additionally is increased. Ideally, manual refilling is completely omitted.

Alternative or particularly advantageous embodiments of the windscreen wiper water system according to the invention are disclosed hereinafter.

The invention relates to a wiper water collection device for all types of motor vehicle, filtering and purifying of the collected water, production of a mixture of wiper-wash water and anti-freeze, depending on the outside temperature, for cleaning motor vehicle windscreens, the rain water or washing water which falls onto the motor vehicle being collected by a water collection device and fed to a wiper-wash container via a supply line, irrespective of whether the motor vehicle is stationary or mobile.

A valve may close the supply line.

When the valve is closed, the water may flow out into the surrounding environment.

This water is initially coarsely filtered in the collection tank in a single-stage or multiple-stage process.

Coarse filtering is achieved with sieves containing holes of decreasing size.

This water is finely filtered and chemically purified by a further filter or filter element. Sediments are separated.

Fine filtering is achieved with filter elements containing holes of decreasing size, sediment spaces being provided between the filter sieves.

Minerals and salts are removed from said water in a single stage or a plurality of stages via a mixed bed demineraliser.

The mixed bed demineraliser is an ion exchanger, also known as a cation and anion exchanger.

Liquid wax is removed from said water in a single stage or a plurality of stages via a wax absorber.

The wax absorber consists of fine filter paper, chromatography paper and/or fleece.

The purified water arrives in a wiper-wash container.

Anti-freeze and surfactants from a separate anti-freeze container may be added to the water in the wiper-wash container. The two containers are connected.

Depending on the temperature and depending on the fluid level in the anti-freeze container and the wiper-wash container, anti-freeze and surfactants may be added to said water at the correct dosage.

Control electronics detect via an anti-freeze sensor the mixture ratio in the wiper water collection container of water and anti-freeze and thus the freezing point of the mixture.

Control electronics detect the outside temperature via the outside temperature signal through the CAN-bus interface.

Control electronics control the valve for the water inflow and activate the mixing pump when required so, depending on the outside temperature and the fluid level in the anti-freeze container, which is detected with a sensor, a correct mixture ratio of water and alcohol in the wiper-wash container can be produced which is also frost resistant under all operating conditions.

The anti-freeze content of the wiper water in the container is measured by the anti-freeze sensor via the conductance and density of the alcohol-water mixture.

Depending on the mixture ratio of anti-freeze and water, the dielectric and the resistance in the sensor vary. This variation is converted by means of a connected RC oscillator into a variable frequency (output Q) which is measured by a control device (microprocessor).

In the control device, the characteristic line of the sensor is stored for linearization, so the concentration of the anti-freeze and the associated frost resistance of the wiper-wash mixture in the container can be calculated.

The outside temperature is compared to the freezing point temperature of the fluid in the wiper-wash container via the CAN-bus signal of the motor vehicle from the control device.

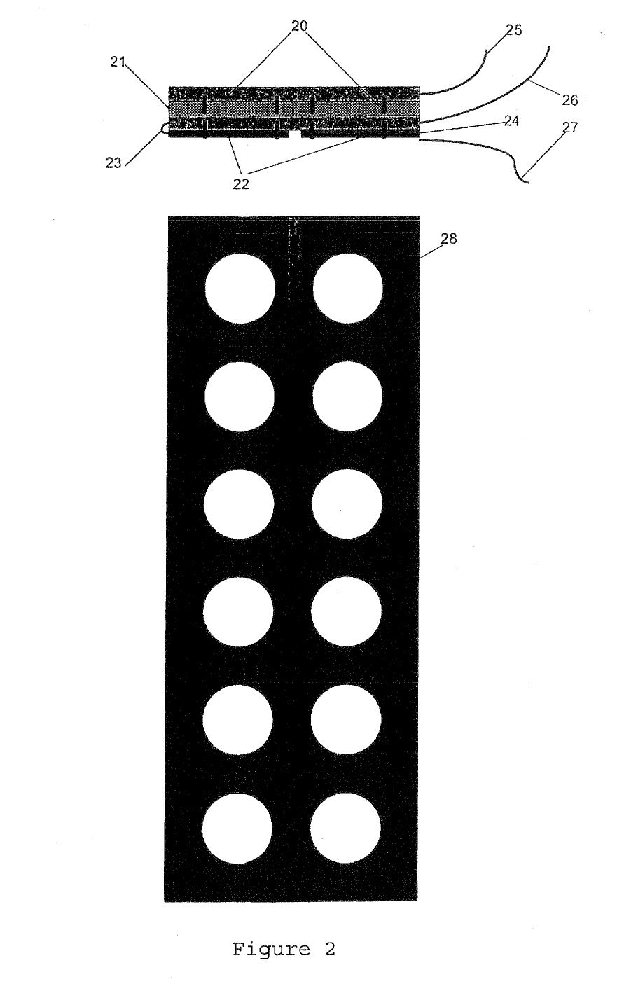

The anti-freeze sensor is configured as shown in FIG. 2 and consists of a capacitively varying part and a resistance varying part.

In the capacitively varying part of the anti-freeze sensor, a fibreglass woven fabric is used as a dielectric.

When the outside temperature falls, the mixing pump is activated by the control device and feeds further anti-freeze from the anti-freeze container to the wiper-wash container.

Further features, advantages and details of the invention are disclosed in the following description of embodiments with reference to the drawings, in which:

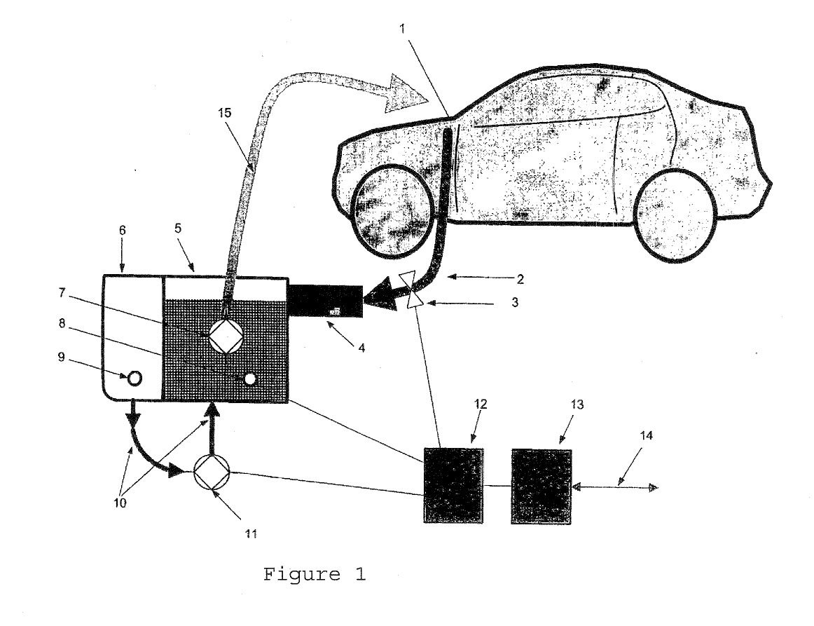

FIG. 1 is an embodiment of a windscreen wiper water system for a motor vehicle with multiple-stage filtering of the collected water and with an anti-freeze sensor,

FIG. 2 is an embodiment of an anti-freeze sensor used in the windscreen wiper water system according to FIG. 1,

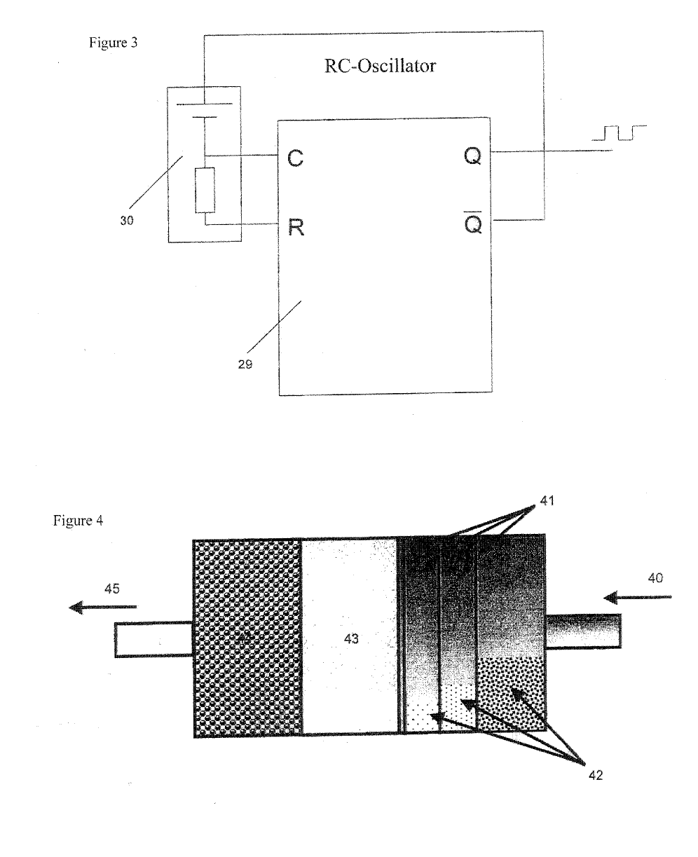

FIG. 3 is a switch used to evaluate an anti-freeze sensor according to FIGS. 1 and 2, and

FIG. 4 is an embodiment of a filter unit used in the windscreen wiper water system according to FIG. 1 to filter collected water.

FIG. 1 shows the entire arrangement of an automatic wiper-wash system (AWW system). Said system comprises the following parts, shown in FIG. 1:

A collection tank 1 in which rain water which has fallen onto the motor vehicle is collected, a supply pipe 2 to a wiper-wash container 5, a valve 3 which can close the inflow, a multiple-stage filter unit 4 (filter, water treater and dewaxer), an anti-freeze container 6 for an anti-freeze/surfactant mixture, a spray pump 7, an anti-freeze sensor 8 for measuring the concentration of water and alcohol in the wiper-wash container 5 with an additional fluid level function, a fluid level sensor 9 for the antifreeze/surfactant mixture in the anti-freeze container 6, a hose connection 10 extending from the anti-freeze container 6 via a mixing pump 11 to the wiper-wash container 5, control electronics 12, a CAN-bus interface 13, a CAN-bus 14 of the motor vehicle for transmitting an outside temperature signal and a hose 15 extending from the wiper-wash container 5 to the spray nozzles.

The anti-freeze sensor 8 shown in more detail in FIG. 2 is composed at least of the following parts:

two metal pole flanges 20, a dielectric 21, resistance layers 22, an electrical connection 23, an insulating layer 24, a connection 25 to the capacitor terminal, a centre terminal 26 between the capacitor and the resistance layer 22 and a connection 27 to the resistance layer 22. Reference numeral 28 denotes a plan view of the perforated pole flanges 20.

The measuring circuit/RC oscillator shown in FIG. 3 has the following parts:

an oscillator component 29 and an anti-freeze sensor 30, shown in the form of an operational diagram.

The filter unit according to FIG. 4 is a compact arrangement configured as a filter/water treatment system. It comprises the following parts:

a water inlet 40 for contaminated water, filter elements 41 in three stages, sediment chambers 42, a wax filter 43, a demineraliser 44 and a water outlet 45 for purified water.

As will be described hereinafter in greater detail with reference to FIG. 1, the system according to the invention has at least two receptacles. One of them stores a conventional commercial anti-freeze, which can be partially mixed with a cleaning agent. The other receptacle stores washing water, which has been mixed depending on the outside temperature, for cleaning the windscreen. Water which falls onto the car is collected, filtered in a plurality of stages and purified and treated for further use in the motor vehicle washing system. The frequency with which the wiper water must be manually refilled is thus greatly reduced.

The water is collected in the collection tank 1, coarsely filtered and is subjected to one or more cleaning stages 4, before it arrives in the wiper-wash container 5 of the motor vehicle.

A valve 3 controls the flow of the water to be purified depending on the fluid level in the wiper-wash container 5 of the motor vehicle. A linear fluid level sensor 8 detects the fluid level in the wiper-wash container 5. If the NOMINAL fluid level in the wiper-wash container 5 is reached, the supply valve 3 closes and the rest of the collected water is outwardly drained off.

The supply valve 3 also closes if, at minus temperatures, another linear fluid level sensor 9 detects that there is no more anti-freeze in the anti-freeze container. This hinders dilution of the mixture of anti-freeze and water present in the container 5 and prevents the wiper water from freezing.

Refilled drinking water contains salts and minerals. Also, in winter, deicing salt from the motor vehicle windscreen arrives in the washing water via the wiper water collection device 1. This salt would be applied again to the motor vehicle windscreen during the cleaning process, and would lead to smears on the windscreen during the washing process thereof and thus be detrimental to usability and customer acceptance.

According to the invention, this restriction to use is remedied, in particular, in that the water is chemically purified by means of a single-stage or multiple-stage mixed bed demineralisation. The efficiency and purifying ability of the mixed bed demineraliser 4 decreases after a specific time or after a specific mineral throughput.

Water from car washes is mixed in the last stage of the washing programme with liquid wax. This wax is removed from motor vehicle windscreens during operation of the car wash by hand with fleece cloths. If water containing wax arrives in the wiper-wash container 5, this may lead to smears on the motor vehicle windscreen during the cleaning process thereof since wax is smeared time and time again when the cleaning fluid is sprayed.

This is preferably taken into account in that the water is cleaned in a single-stage or multiple-stage process by a wax absorber 4. The wax absorption is achieved by fine filter paper and/or compressed fleece, which is arranged in a plurality of layers. Wax forms in emulsion micelles of varying size. These amphiphilic molecules are too large to pass through the filter paper or compressed fleece.

The multiple-stage filter/dewaxer 4 is expediently configured as an exchangeable cartridge in such a way that it may be replaced quickly and at low cost.

The wiper-wash container 5 is supplied with anti-freeze and a cleaning agent from one or two separate containers 6. Via the CAN-bus interface 13 of the motor vehicle, the electronic control unit 12 obtains information regarding the current outside temperature 14. Taking this outside temperature into consideration, the concentration of anti-freeze is measured with a sensor 8 on as to achieve a temperature-compatible mixture of the anti-freeze in the wiper water in the wiper-wash container 5. The signal of the sensor 8 is detected by the control unit 12. This controls, according to predetermined parameters, the mixing pump 11 of the anti-freeze supply container 6 which pumps anti-freeze into the wiper-wash container 5. As a result, only as much anti-freeze is supplied as dictated by the outside temperature (signal from the CAN-bus 14). This means that these resources are used economically. This also protects the environment since less anti-freeze is dispersed in the atmosphere.

The pump 7 carries the wiper water to the spray nozzles.

The anti-freeze sensor 8 is described hereinafter in greater detail with reference to FIGS. 2 and 3.

Construction: the anti-freeze sensor substantially consists of two insulated pole flanges 20 and a low-resistance dielectric 21 which is preferably made of an absorbent material, such as, for example, a fibreglass woven fabric.

Arrangement: the dielectric 21 is arranged between the two pole flanges 20. Connected to the upper pole flange 20 is a wire 25 which is in turn connected to the rear coupling output (R) of the RC oscillator 29. The lower pole flange is connected via a wire 26 to the C input (C) of the RC oscillator 29 and has a further connection 23 to the left-hand resistance layer 22 which is arranged on the sensor, in particular on the lower side of the lower pole flange 20. From the right-hand resistance layer 22, which is insulated from the lower pole flange 20 by means of the insulating layer 24, a further wire 27 passes to the R input of the RC oscillator 29.

Mode of operation: the two pole flanges 20 form an electrical capacitor together with the dielectric 21. The dielectric 21 varies its ∈ᵣ value, which is the factor of the multiple of air, by which the capacitance is higher than in the air between the pole flanges 20 when anti-freeze (for example ethyl alcohol) is fed to the pure or purified water. In addition, the conductance, which differs with pure water or pure alcohol, is detected at the sensor via the resistance layer 22. The changes in resistance and capacitance are, depending on the mixture ratio, converted by the connected RC oscillator 29 into an output signal of variable frequency which can be picked up at the Q output and is measured by the control device 12 (for example a microprocessor unit). For linearization, the characteristic of the sensor 8 is stored in the control device 12 in such a way that the concentration of the anti-freeze and the associated frost resistance of the wiper-wash mixture are detected. The outside temperature 14 is compared by the control device 12 to the freezing point temperature. If the outside temperature falls, further anti-freeze is supplied by the control device, which activates the mixing pump 11.

The filter unit configured as a filter and water treatment cartridge will be explained in greater detail hereinafter with reference to FIG. 4 and also with reference, in part, to FIG. 1.

Contaminated water is fed to the filter and water treatment cartridge from the pipeline 2. The colleted water is purified in two, three or more substages via a fine filter 41 (first main stage). During this process, the sediment chamber receives the impurities. The filter housing consists of an oil and acid resistant housing made of metal or plastics material.

In a second main stage, the water flows through a wax absorber 43, in which the wax, which is added in the last stage of the washing process, for example at car washes, is filtered out through fine filter paper (for example chromatography paper) and/or compressed fleece.

In a third main stage, the water flows through a mixed bed demineraliser 44, also known as a cation and anion exchanger, which allows both positively loaded minerals and negatively loaded acid radicals to be neutralised.

The water which leaves the filter may be referred to as completely purified, demineralised and dewaxed water. Said water flows into the mixture container 5 to be used further as a medium for cleaning windscreens.

1. Windscreen wiper water system for all types of motor vehicle comprising:
a water collection device (1) for collecting rain water or car wash water falling onto the motor vehicle as collected water,
means (4) for filtering and purifying collected water,
a wiper-wash container (5),
a supply line (2) for feeding the collected water to the wiper-wash container (5) and
means (8, 9, 10, 11, 12, 13, 14) for producing a mixture of wiper-wash water and anti-freeze, depending on the outside temperature, for cleaning motor vehicle windscreens.

2. Windscreen wiper water system according to claim 1, characterised in that a valve (3) is provided for closing the supply line (2).

3. Windscreen wiper water system according to claim 2, characterised in that drainage means are provided for draining the water into the surrounding environment when the valve (3) is closed.

4. Windscreen wiper water system according to claim 1, characterised in that the water collection device (1) is configured for coarsely filtering the collected water in a single-stage or multiple stage process.

5. Windscreen wiper water system according to claim 4, characterised in that sieves with holes of decreasing size in a water flow direction are provided for a preliminary process of coarse filtering.

6. Windscreen wiper water system according to any one of claims 1 to 5, characterised in that a further filter or a further filter element (4) is provided for finely filtering and for chemically purifying the collected water as well as for separating sediment from the collected water.

7. Windscreen wiper water system according to claim 6, characterised in that a plurality of filter elements with holes of decreasing size in a water flow direction and sediment chambers between the filter elements are provided for fine filtering.

8. Windscreen wiper water system according to claim 6, characterised in that a single-stage or multiple-stage mixed bed demineraliser is provided for removing minerals and salts from the collected water.

9. Windscreen wiper water system according to claim 8, characterised in that the mixed bed demineraliser is an ion exchanger, in particular a cation and anion exchanger.

10. Windscreen wiper water system according to claim 6, characterised in that a single-stage or multiple-stage wax absorber is provided for removing liquid wax from the collected water.

11. Windscreen wiper water system according to claim 10, characterised in that the wax absorber contains a fine filter paper, a chromatography paper or a fleece.

12. Windscreen wiper water system according to any one of claims 1 to 11, characterised in that a separate anti-freeze container (6) connected to the wiper-wash container (5) is provided for receiving anti-freeze and, in particular, surfactants, it being possible to add the anti-freeze and the surfactants from the anti-freeze container (6) to the water in the wiper-wash container (5).

13. Windscreen wiper water system according to claim 12, characterised in that means are provided for mixing the water in the wiper-wash container (5) with the anti-freeze and the surfactants at a predetermined or predeterminable dosage, depending on temperature, the fluid level in the anti-freeze container (9) and the fluid level in the wiper-wash container (5).

14. Windscreen wiper water system according to claim 13, characterised in that control electronics (12) and an anti-freeze sensor (8) are provided for detecting a mixture ratio in the wiper-wash container (5) of water and anti-freeze and therefore for determining the freezing point of the mixture of water and anti-freeze.

15. Windscreen wiper water system according to claim 13, characterised in that control electronics (12) connected to a CAN-bus interface (13) are provided for detecting an outside temperature by means of an outside temperature signal (14) transmitted to a CAN-bus of the motor vehicle.

16. Windscreen wiper water system according to claim 2 and claim 13, characterised in that control electronics (12) controlling the valve (3) for closing the supply line (2), a mixing pump (11) and a sensor (9) for detecting the fluid level in the anti-freeze container (6) are provided, and the control electronics (12) for activating the mixing pump (11) when required are configured in such a way that, depending on outside temperature (14) and the fluid level in the anti-freeze container (6), a predetermined or predeterminable mixture ratio of water and alcohol which is also frost resistant under all operating conditions can be adjusted in the wiper-wash container (5).

17. Windscreen wiper water system according to claim 14, characterised in that the anti-freeze sensor (8) is configured for detecting the content of anti-freeze in the mixture in the wiper-wash container (5) by means of electric conductance and density of the mixture in the wiper-wash container (5).

18. Windscreen wiper water system according to claim 14, characterised in that the anti-freeze sensor (8) comprises a dielectric which varies depending on the mixture ratio of the mixture in the wiper-wash container (5) and a resistance which also varies, the anti-freeze sensor (8) is connected to an RC oscillator (29) which converts a resistance variation into a variable frequency, and the control electronics (12) are configured for detecting said variable frequency.

19. Windscreen wiper water system according to claim 14, characterised in that a characteristic of the anti-freeze sensor (8) is stored in the control electronics (12) for linearization in such a way that it is possible to calculate the concentration of the anti-freeze and the associated frost resistance of the mixture in the wiper-wash container (5).

20. Windscreen wiper water system according to claim 14 and claim 15, characterised in that the control electronics (12) are configured for comparing the outside temperature determined using the outside temperature signal (14) transmitted to the CAN-bus of the motor vehicle with a freezing point temperature of the mixture in the wiper-wash container (5).

21. Windscreen wiper water system according to claim 14, characterised in that the anti-freeze sensor (8) comprises a capacitively variable part (20, 21) and a resistance variable part (22).

22. Windscreen wiper water system according to claim 21, characterised in that the capacitively variable part contains a fibreglass-type woven fabric (21) as a dielectric.

23. Windscreen wiper water system according to claim 16, characterised in that the control electronics (12) are configured for activating the mixing pump (11) when the outside temperature falls, as a result of which it is possible to feed further anti-freeze from the anti-freeze container (6) to the wiper-wash container (5).
